(19) United States
(12) Patent Application Publication
(10) Pub. No.: US 2017/0094946 A1
(43) Pub. Date: Apr. 6, 2017

(54) System and Method for Wireless Charging of Pet Products

(71) Applicant: PeTrak, LLC, Stroudsburg, PA (US)

(72) Inventor: Salvatore John Giunta, Stroudsburg, PA (US)

(21) Appl. No.: 15/287,193

(22) Filed: Oct. 6, 2016

Related U.S. Application Data
(60) Provisional application No. 62/237,692, filed on Oct. 6, 2015.

(51) Int. Cl. A01K 27/00; H02J 7/00; H02J 50/12; G01S 19/14; A01K 15/02; A01K 1/035; A01K 11/00; A01K 29/00; H02J 7/02; H02J 50/80

(52) U.S. Cl. CPC A01K 27/009; H02J 7/025; H02J 7/0052; H02J 50/12; H02J 50/80; A01K 27/001; A01K 15/023; A01K 1/0353; A01K 11/008; A01K 29/005; A01K 15/022; G01S 19/14

(57) ABSTRACT

A pet product adapted for automatic, unattended recharging includes an wireless charging system having at least two coils. One coil, which is attached to an external source of electrical power, is disposed in a pet mat, bed, or near to a location where a pet is expected to spend significant time. A second coil is electrically coupled to a rechargeable battery in the pet product, which is typically attached to the pet's collar.

### STATEMENT OF RELATED CASES

This disclosure claims priority of U.S. Pat. App. Ser. No. 62/237,692 filed Oct. 6, 2015, which is incorporated by reference herein.

### FIELD OF THE INVENTION

The present invention relates generally to pet products, and more particularly to battery-powered pet products.

### BACKGROUND OF THE INVENTION

There are numerous electronic pet products in widespread use today that utilize, as all or part of their system, a collar-mounted module (hereinafter “collar module”) comprising a housing, electronic circuitry, and a rechargeable energy storage device, such as a battery, etc. A specific portion of the electronic circuitry, which portion is referenced herein as a “receiver,” is used to detect, sense, or otherwise receive electrical or mechanical signals or to collect some form of information or data (hereinafter referenced collectively as “signals”). These signals may be from another component of the product such as a base station, controller or transmitter, or from public sources, such as GPS or other GNSS satellite or location services (hereinafter referenced collectively as “GPS”). These signals, as transmitted or received, may be information bearing or not and may be in the form of sound or inertial data.

One example of such a pet product is a virtual fencing system, which is used by a homeowner to prevent the family pet, usually a dog, from wandering away from their property. One type of virtual fencing system employs a buried wire that defines a containment boundary. The wire radiates a signal that is sensed by a collar module that is worn by a monitored animal. As the monitored animal approaches the boundary, the signal is sensed and the device delivers a correction (e.g., sound, electric shock, etc.) to the animal to dissuade it from breaching the boundary. The term “correction” is used hereinafter to collectively refer to warnings (sound, vibration, etc.) and/or stimulus (electric shock, citronella discharge, etc.).

Another type of virtual fencing system uses a wireless positioning system, such as GPS, to establish a boundary and determine an animal's location. This type of system includes a collar module, worn by the animal, which typically includes a GPS positioning receiver, a means for applying a correction, suitable control and logic circuitry/software (hereinafter referred to collectively as a “processor”), and a battery. The collar module establishes a containment boundary. The boundary is defined by positional coordinates, which are obtained from the GPS positioning receiver. In use (after the boundary is defined), the processor compares the position of the receiver (i.e., the position of a monitored animal) as determined real-time by the GPS positioning receiver, with the containment boundary. In some such systems, as the animal approaches a warning zone near the boundary, a warning is delivered. If the animal continues toward the boundary, a stimulus is typically administered to the animal.

In a buried-wired system, if an animal attempts to return to the original containment zone, it will be corrected (i.e., receive a stimulus) as it nears the wire. This provides a disincentive to return to the containment zone. Furthermore, in such systems, the ability to control the animal is lost once breach occurs. By contrast, in some wireless fencing systems, there is no disincentive for an animal to re-cross a breached boundary. Some such systems can suspend correction once breach occurs. Also, some such systems have the ability to dynamically change the boundary, which effectively suspends correction and, more importantly, regains control of an animal after breach has occurred.

There are, however, some drawbacks associated with wireless fencing systems. One drawback relates to power consumption. In particular, wireless fencing systems consume power at a greater rate than buried-wire systems. This is a consequence of location (i.e., GPS) readings, which are obtained during operation of a wireless system. Furthermore, some of the wireless systems incorporate various sensors for evaluating specific types of animal movement. The operation of such sensors also consumes power. Furthermore, some of the wireless systems incorporate radio transmitters or transceivers to communicate with a base station, Smartphone or other device. These transmitters and transceivers are also power consumers.

The relatively greater power consumption associated with wireless fencing systems requires recharging the battery in the collar module on a relatively frequent basis.

### SUMMARY

The present invention provides for automatic, unattended recharging of an energy-storage device as used in pet products, such as, without limitation, wireless-fencing systems. The energy storage device, which can be a rechargeable battery, super capacitor, a combination of both, etc., is hereinafter referred to collectively as a “rechargeable battery”, or simply “battery”.

There are numerous electronic pet products that are at least partly contained within a module mounted to a collar affixed around the neck of the pet. These collar modules contain a rechargeable battery, and various other electronic components as their specific functions may require. It is necessary to periodically recharge these devices, which mandates removal of the product from the animal for as long a period-of-time as may be required to achieve a full recharge. The inventor recognized that a far better solution would be to implement a wireless recharging system that would not require removal of the collar from the pet and that would automatically recharge the battery without the intervention or attention of the pet owner.

In accordance with the illustrative embodiment, any of a variety of electronic pet products include a wireless (i.e., inductive) charging system. Although most beneficial for wireless fencing systems (e.g., RF signal strength, GPS, WiFi, etc.), embodiments of the invention are also useful in conjunction with buried-wire fencing systems. And in some additional embodiments, the present teachings can be applied to provide automatic, unattended recharging of other pet products such as, and without limitation:
various locators/trackers for pets, field-trial dogs and hunting dogs;
automatic pet and kennel doors triggered by unidirectional or bidirectional radio signals, ultrasonic signals, or other non-contact means;
bark control collars used to modify a dog's barking behavior; and
activity monitors that measure and relay physical activity data of a pet either continuously, periodically, or upon demand.

In some embodiments, the wireless charging system comprises two coils. One coil, which is attached to a source of power, is disposed in a pet mat, blanket, bed or other device near or upon which an animal could reasonably be expected to spend significant time. In the illustrative embodiment, this coil (hereinafter referred to as the “transmitting coil”) receives low-voltage power from a wall-mount power supply, suitable for use indoors or outside. The transmitting coil is typically encapsulated in a waterproof plastic casing and is referred to hereinafter as a “charging pad.” The charging pad may incorporate a permanent magnet to facilitate holding the charging pad against the collar unit in proper alignment with the receiving coil. The transmitting and receiving coils may each incorporate a shielding plate in accordance with one or more of the wireless charging standards (e.g., Qi, Powermat, A4WP, etc.) in order to minimize heating of surrounding metal objects and minimize the required number of coil turns for a given design. In instances where a shielding plate is employed, the holding magnet within the charging pad will be attracted to the shielding plate within the collar module. If a shielding plate is not employed, the magnet will be attracted to a metal (i.e., steel) disc typically found within rechargeable pet-product collar modules employed to hold these modules securely in place and to maintain good electrical contact when positioned upon their respective conventional (non-wireless) external chargers.

The second coil (hereinafter referred to as the “receiving coil”) is electrically coupled to the rechargeable battery in the collar module, which is typically attached to the pet's collar.

In some embodiments, the wireless charging system uses resonant inductive charging, which increases the range or distance over which the charging energy can be transmitted. In resonant inductive charging, the two coils are each part of resonant circuits that are tuned to resonate at the same frequency.

In some other embodiments, the wireless charging system comprises, in addition to the coils (and, in some embodiments, resonant circuits), Bluetooth or other active or passive communications or proximity-detection circuitry to initiate and control the charging regime. Active communication circuitry can be unidirectional (e.g., signaling some information from the charger to the collar module or vice versa, or to the pet owner, etc.) or bidirectional (e.g., handshake signals between charger and collar module acknowledging detection and charging initiation, collar module signaling back to the charger to adjust power level, or to determine that charging is complete and terminate the charge cycle, etc.,). Passive communication circuitry can, for example, detect the induced voltage in the receiving coil or detect the reflected load in the transmitting coil when the coils are in close proximity.

One advantage of embodiments of the invention is that battery recharging occurs, fully or partially, anytime the rechargeable battery (which is typically in the collar module on the pet's collar) and charging pad are in close proximity. This can be overnight on a bed or during the day on a mat or blanket that the pet lays on, or against a wall.

As previously indicated, in some embodiments the transmitting coil(s) are encapsulated within a waterproof casing and are hereinafter referred to as the charging pad. In some embodiments, the charging pad may be embedded within a pet bed, mat, or blanket. In some other embodiments, the wireless charging system comprises a flat, standalone (i.e., non-embedded) charging pad upon which the customer could place a standard pet bed, mat, or blanket. If the pet sleeps on its master's bed, the standalone charging pad can be placed on that bed. In yet some further embodiments, the charging pad is disposed in a linear housing that mounts upon, or sits adjacent to, the base molding of a wall where the pet normally lays or sleeps.

In some embodiments, multiple transmitting coils are disposed within the embedded or standalone charging pad to facilitate better coupling of the transmitting and receiving coils. In yet some further embodiments, multiple receiving coils are disposed within the collar module or within the collar strap itself (and electrically connected to the collar module) to facilitate better coupling of the transmitting and receiving coils.

In some embodiments, multiple charging pads or an enlarged charging pad with multiple sets of one or more spatially separated coils, may be disposed within a pet bed, mat, or blanket to accommodate more than one pet concurrently.

In some embodiments, a transmitting coil is disposed in an asymmetrical position within a pet bed, mat, or blanket to facilitate repositioning by reversing and or flipping over the pet bed, mat or blanket.

In some embodiments, a transmitting coil is disposed within a molded plastic housing connected with a retractable cord. A cord retracting mechanism is disposed along the length of the flexible cord between the charging pad and the power module. The retractor is positioned such that there is sufficient cord on one side to conveniently connect the power module to a wall outlet or other source of power and so that there is sufficient cord on the other side to extend the charging pad to reach from where the retractor is affixed or positioned to where the collar is on a pet lying adjacent to the charger.

As previously indicated, transmitting coils are disposed singly or in multiples in various layouts. Where a single transmitting coil might be placed, in some embodiments, plural charging coils are disposed in a close, symmetrical flower-like pattern in place of the single coil.

In some embodiments, an audible tone, series of tones, or blinking lamp(s) indicate proper coupling level of the transmitting and receiving coils. To create the tone, in some embodiments, a small audio transducer (e.g., speaker, piezo device, buzzer, etc.) is incorporated within the charger module. To generate light, a small light emitter(s) (e.g., LED, incandescent lamp, etc.,) is incorporated within the charger module.

In some embodiments, charging communication circuitry is employed, wherein the charging communication circuitry is used for one or more of the following purposes, among any others:
detection of a collar unit
initiation and control of the charging regime
feedback to the user about the positioning of the charging pad with respect to the collar unit
feedback to the user of the level of the energy transfer (i.e., some percentage ofmaximum capability)
present charging status.

In some embodiments, a Smartphone app is used to determine the optimum position of the transmitting coils and/or their coupling level with the receiving coil(s). Most, if not all, Smartphones have Bluetooth capability for communicating with other devices (e.g., car audio system, wireless speaker, etc.) and this capability is used to link the phone to the charger. In some embodiments of the invention, the wireless charging integrated circuits have integral Bluetooth capability. In some other embodiments a discrete or separate Bluetooth radio is employed. Those skilled in the art will know how to design an application for the Smartphone that enables the Smartphone to communicate with the inductive charging system and provide audible and or visual feedback of the charging activity to the user.

### BRIEF DESCRIPTION OF DRAWINGS

FIG. 1 depicts an electronic pet product including a wireless charging system in accordance with the illustrative embodiment of the present invention.

FIG. 2 depicts an illustrative embodiment of a charging base of the wireless charging system of FIG. 1.

FIG. 3A depicts a first embodiment of a charging pad of the charging base of FIG. 2.

FIG. 3B depicts a second embodiment of a charging pad of the charging base of FIG. 2.

FIG. 3C depicts a third embodiment of a charging pad of the charging base of FIG. 2.

FIG. 3D depicts a fourth embodiment of a charging pad of the charging base of FIG. 2.

FIG. 3E depicts a fifth embodiment of a charging pad of the charging base of FIG. 2.

FIG. 4 depicts an illustrative embodiment of a power module of the charging base of FIG. 2.

FIG. 5A depicts a pet bed that incorporates the charging base.

FIG. 5B depicts a pet bed that incorporates the embodiment of the charging base of FIG. 3E.

FIG. 5C depicts a floor mat that incorporates the charging base.

FIG. 5D depicts a wall mounted structure that incorporates the charging base.

FIG. 6 depicts a schematic of an illustrative embodiment of the collar module of the wireless charging system of FIG. 1.

FIGS. 7A-7D depict illustrative product-specific circuitry of the collar module as a function of the nature of the electronic pet product.

### DETAILED DESCRIPTION

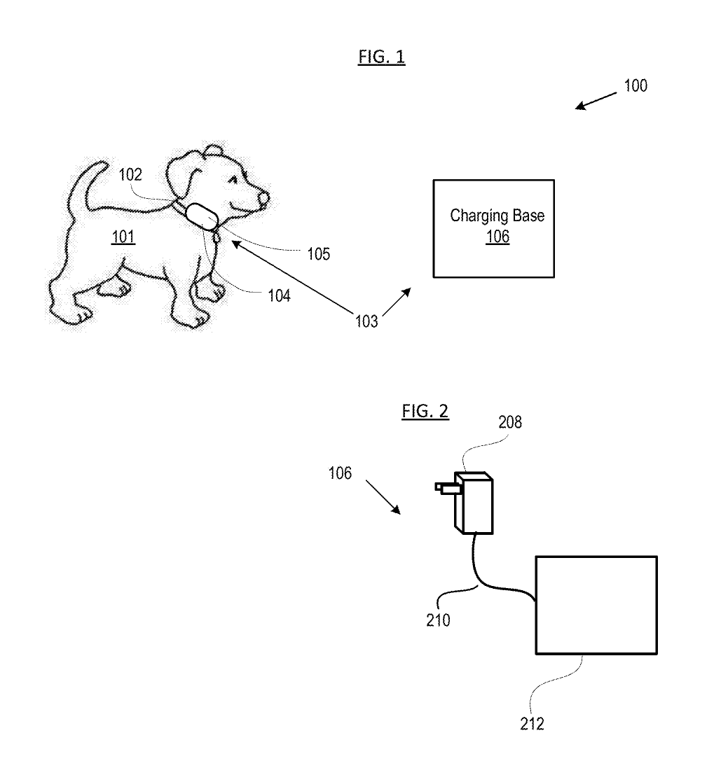

FIG. 1 depicts dog 101 and electronic pet product 100 incorporating wireless charging system 103 in accordance with the illustrative embodiment of the present invention. Pet product 100 is implemented, at least in part, via collar module 104. Collar module 104 is coupled to (or forms a part of) collar 102, which is fitted to the neck of dog 101. Collar 102 may be a neck strap, harness, or other means to affix and support collar module 104. The collar module comprises battery-powered circuitry and devices that, at least in part, provide the functionality of pet product 100. A portion of wireless charging system 103 resides within collar module 104; namely, wireless charging circuitry 105. The wireless charging system further includes charging base 106.

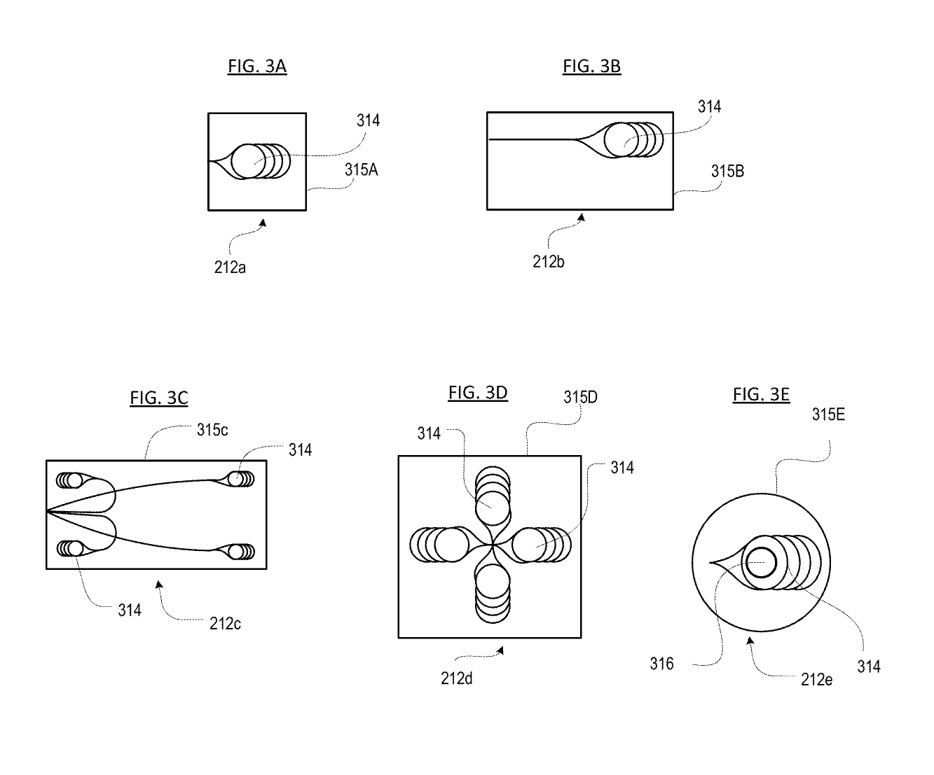

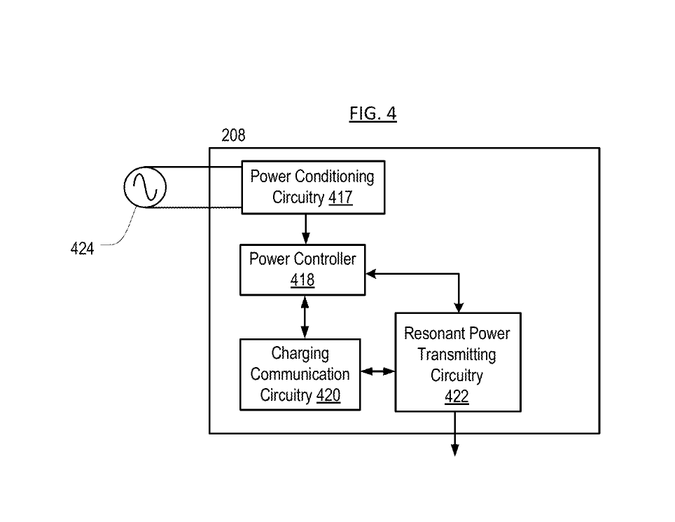

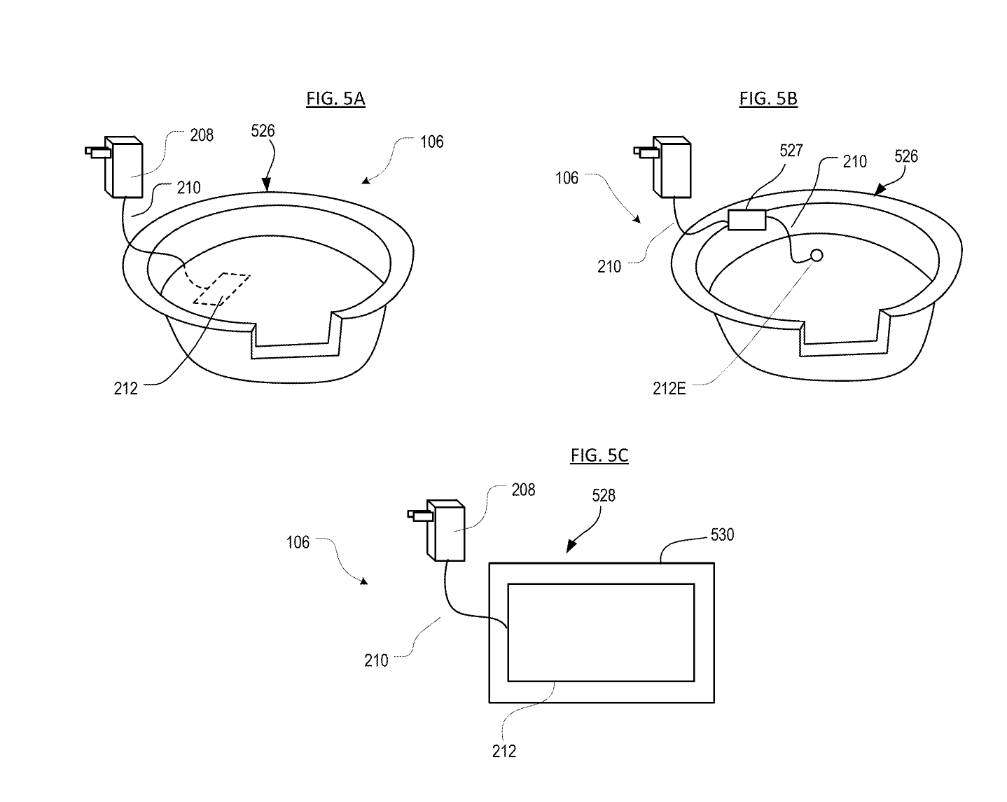

FIG. 2 depicts an illustrative embodiment of charging base 106. The charging base comprises power module 208, electrical cable 210, and charging pad 212. The charging pad includes power-transmitting circuitry, described in conjunction with FIGS. 3A-3E. Electrical cable 210, which is flexible, conducts power, sourced from any conveniently available electrical power system, to charging pad 212. Power module 208, which is depicted in more detail in FIG. 4, includes various circuitry/devices for conditioning the power, controlling charging, and providing other related functionality. The power module 208 is disposed in an oversized electrical plug (i.e., a wall wart) or inline along cable 210 (i.e., a brick) or configured in some other form factor known to those skilled in the art. Those skilled in the art will know how to design power module 208 to connect to one or more of the various electrical power systems used throughout the world.

FIGS. 3A-3E depict embodiments of charging pad 212, identified individually as charging pad 212a through 212e and hereinafter collectively or generically as charging pad(s) 212. As previously indicated, charging pads 212 contain circuitry/devices for transmitting the power that recharges the battery in collar module 104. In the illustrative embodiments, this circuitry/devices is embodied in the form of one or more coils. The various embodiments differ mainly in the number and/or location of the coils. In the illustrative embodiment, all charging pads 212 are constructed from plastic material and sealed so as to be waterproof.

FIG. 3A depicts charging pad 212A, which includes a single centrally/symmetrically located transmitting coil 314 disposed in an encapsulating housing 315A. The size of charging pad 212A is as small as possible to accommodate a single transmitting coil (c.a. 2″×2″). As the term is used herein and the appended claims, a “coil” includes multiple “turns” of wire, appropriate for creating the halves of an air-gap transformer. A typical coil may comprise 24 turns of wire and be 1.5″×1.5″ in size.

The design of the coils is based on a multitude of factors and is specific to the type of charger (resonant or non-resonant) and the wireless charging design standard being applied, (e.g., Qi, Powermat, A4WP, etc.). The wire (single or bifilar), number of turns, number of coil layers, and wire gauge, all influence the inductance and dc resistance of the coil, and the resulting voltage gain of the receiving coil and effective power transfer. Coils may be circular, rectangular, or other shape and they may be planar or non-planar. Those skilled in the art will understand how to apply these standards to the circuit and coil design of a wireless charger. As previously mentioned, charging pad 212A has a relatively small form factor (c.a. 2″×2″ for a single coil) and is appropriate for placement under or within a pet bed, cushion, mat, etc., such that the charging pad will be in close proximity with collar module 104 when the pet is on the pet bed, etc.

FIG. 3B depicts charging pad 212b, which includes a single off center/asymmetrically located transmitting coil 314 disposed in encapsulating housing 315B. In some embodiments, charging pad 212B is in the form of a floor mat or disposed within a floor mat. The asymmetrical placement of transmitting coil 314 within charging pad 212B is intended to provide near optimum alignment of transmitting coil 314 with collar module 104. Depending on the preferred position a pet assumes when lying on it, charging pad 212B can be reversed and or flipped over in order to align transmitting coil 314 with collar module 104.

FIG. 3C depicts a plurality of transmitting coils 314 disposed within charging pad 212C. This configuration avoids the need to align charging pad 212C with collar module 104. This embodiment can also accommodate multiple pets, thereby eliminating the need for more than one charging base 106.

FIG. 3D depicts charging pad 212D wherein multiple transmitting coils 314 are disposed in a flowerlike pattern (coils arranged at ninety degrees with respect to one another) within larger (c.a. 5″×5″) encapsulating case 315D. Due to the need for close alignment, the limitation of the size of the receiving coil, and the need to keep the receiving coil the same or slightly smaller (c.a. down to about 70%) than the size of the transmitting coils, a flower pattern having a plurality of coils improves the likelihood of achieving close coupling between the receiving coil and one of the transmitting coils.

FIG. 3E Depicts charging pad 212E wherein single centrally located transmitting coil 314 is disposed concentrically with permanent magnet 316 within very small encapsulating case 315E (c.a. 1″×1″, or 1″ diameter). In this embodiment of charging pad 212, the encapsulating case may be a molded plastic housing sufficient in thickness to accommodate a small magnet and to allow it to be easily grasped and placed on collar module 104. Due to the need for close alignment, the practical limitation of the size of the receiving coil, and the need to keep the receiving coil the same or slightly smaller (c.a. down to about 70%) than the size of the transmitting coils, a magnetically positioned transmitting coil 314 will achieve a very high coupling factor due to the close coupling and precise alignment between the receiving coil 646 and transmitting coil 314. In some embodiments wherein a shielding plate (not depicted) is incorporated within collar unit 104, magnet 316 is attracted to the shielding plate. In some other embodiments wherein a metal (i.e., steel) disc (not depicted) is incorporated within collar unit 104, magnet 316 is attracted to the metal disc.

FIG. 4 depicts an embodiment of power module 208 of charging base 106, comprising power conditioning circuitry 417 to interface with an external supply of electrical power 424 (i.e., an electrical utility grid), power controller 418 to supervise and control the charging function, and transmitting resonant power circuitry 422 to drive transmitting coil 314. Charging communication circuitry 420, which is optional, may be included to facilitate features such as:
1. Detection of the device being charged (i.e., collar module 104) in order to power up transmitting resonant power circuitry 422.
2. Communication with the device being charged (i.e., collar module 104), in order to provide feedback about how well the transmitting coil 314 is coupling with collar unit 104.
3. Determination of which transmitting coil(s) 314 within charging pad 212c are within coupling range of collar unit(s) 104.

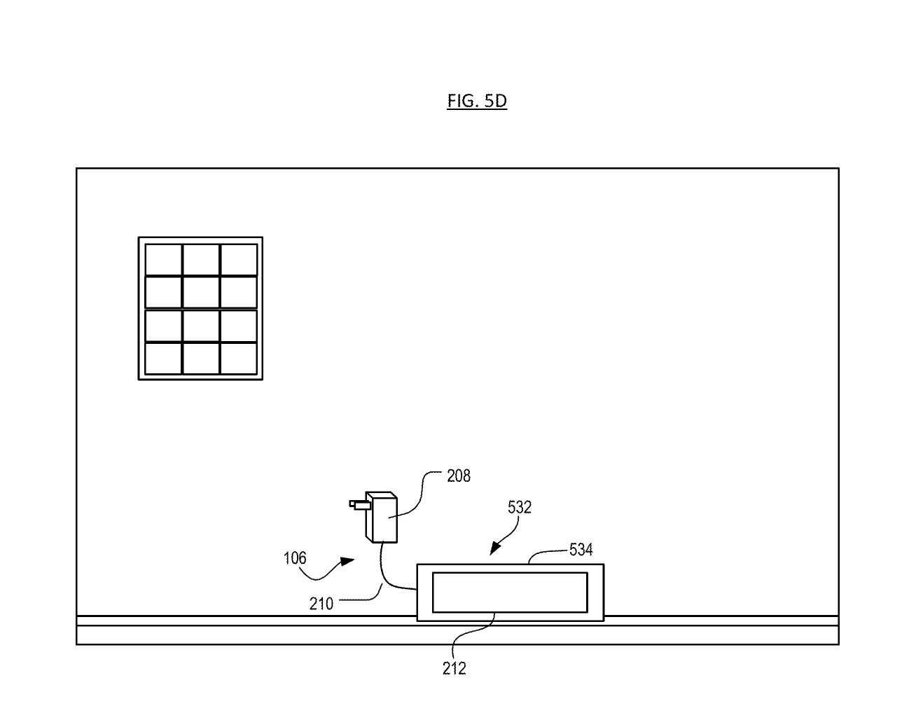

FIG. 5A depicts an embodiment wherein charging pad 212 is disposed within pet bed 526. This enables recharging to take place anytime the pet is within the bed. This provides for nightly recharging which is typically more than the pet product would normally require. Power unit 208 is plugged into a standard wall outlet and flexible electrical cable 210 allows for easy placement of charging pad 212 within pet bed 526.

FIG. 5B depicts an embodiment wherein electrical cable 210 passes through cord retractor 527 to charging pad 212E. Cord retractor 527 retracts charging pad 212E when not in use. Cord retractor 527 may be affixed to the wall, a pet bed, or wherever a pet sleeps or spends significant time lying down. When the pet is within pet bed 526, charging pad 212E may be pulled away from retractor 527 and placed on collar unit 104 where it is held in place by magnet 316. Cord retractor 527 prevents the pet from chewing on cable 210 or becoming entangled with it.

FIG. 5C depicts an embodiment wherein charging pad 212 is disposed within outer casing 530, forming mat 528, which can serve as a household floor, door, or pet mat. This provides for daily recharge periods whenever a pet lies on mat 528. Power unit 208 is plugged into a standard wall outlet and flexible electrical cord 210 allows for easy placement of mat 528.

FIG. 5D depicts an embodiment wherein charging pad 212 is disposed within outer casing 534, forming wall-mounted mat 532. Wall mat 532 is placed adjacent to a pet's favorite spot on the floor. This provides for daily recharge periods whenever the pet lays adjacent to wall mat 532. The power unit 208 is plugged into a standard wall outlet and flexible electrical cord 210 allows for easy placement of wall mat 532.

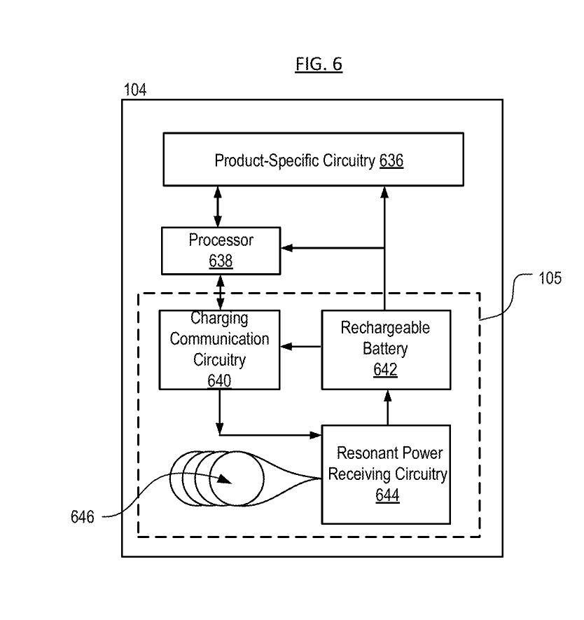

FIG. 6 depicts an embodiment of wireless charging circuitry 105 within collar module 104. Those skilled in the art will know how to design a circuit to receive energy by means of a receiving coil 646 from a transmitting coil 314 connected to an external source of electrical energy (i.e., an electrical utility grid). In the embodiment depicted in FIG. 6, wireless charging circuitry 105 includes resonant power receiving circuitry 644, which harvests energy from receiving coil 646 in order to charge battery 642. Although advantageous, resonant power receiving circuit 644 is optional.

In the embodiment depicted in FIG. 6, wireless charging circuitry 105 includes charging communication circuitry 640, which facilitates features described in conjunction with charging communication circuitry 420 (FIG.4). Charging communication circuitry 640 is optional (although typically included in embodiments that include charging communication circuitry 420).

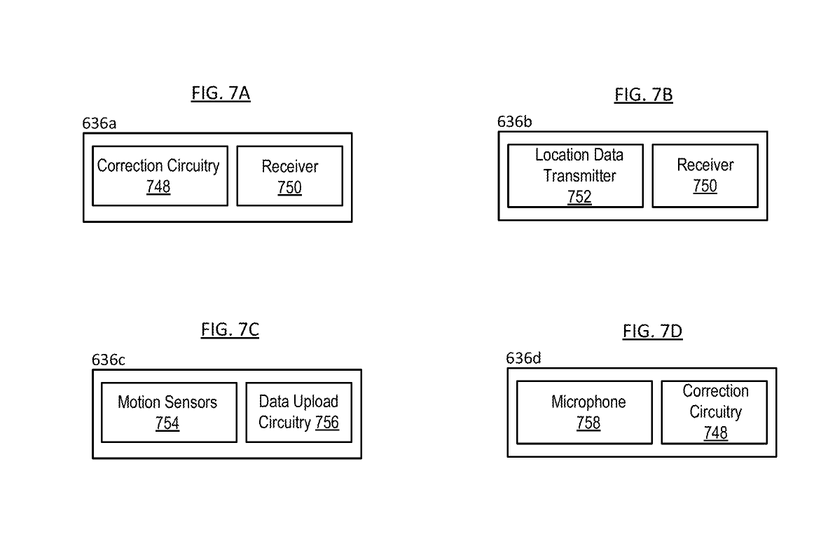

Processor 638 interfaces with and controls wireless charging circuitry 105. Collar module 104 also comprises product-specific circuitry 636, which is specific to the pet product and discussed in further detail in conjunction with FIGS. 7A through 7D.

FIG. 7A depicts salient elements of product-specific circuitry 636A within collar module 104 for embodiments in which the pet product is a virtual fencing system. Product-specific circuitry 636A comprises, without limitation, receiver 750 to detect signals such as GPS, Rf, WiFi, or the field emitted by the wire of a buried wire fence and correction circuitry 748 that provides a warning, and if necessary, a correction to the animal based on evaluation of the signals received by processor 638 (see FIG. 6).

FIG. 7B depicts salient elements of product-specific circuitry 636B within collar module 104 for embodiments in which the pet product is a tracking device, such as is used with hunting and field trial dogs. Product-specific circuitry 636B comprises, without limitation, receiver 750 to detect position signals such as GPS and location data transmitter 752 to relay position data (e.g., coordinates, or distance and direction data, etc.) to a hand-held tracking unit. Collected data is processed and formatted as necessary for transmission by processor 638 (see FIG. 6).

FIG. 7C depicts salient elements of product-specific circuitry 636C within collar module 104 for embodiments in which the pet product is an activity monitoring device, such as can be used to determine if a pet is getting sufficient exercise. Product-specific circuitry 636C comprises, without limitation, motion sensors 754 to detect the magnitude, or magnitude and direction, of motion of the pet. Collected data is processed and formatted as necessary and stored for transmission or upload by data upload circuitry 756 and processor 638 (see FIG. 6).

FIG. 7D depicts product-specific circuitry 636D within collar module 104 for embodiments in which the pet product is a bark collar, such as is used to correct the barking behavior of a dog. Product-specific circuitry 636D comprises, without limitation, microphone 758 to detect the presence and magnitude of barking sounds made by the pet and correction circuitry 748 to provide warning and, if necessary, correction to the animal based on evaluation of the signals received by the processor 638.

It is to be understood that the disclosure teaches just one example of the illustrative embodiment and that many variations of the invention can easily be devised by those skilled in the art after reading this disclosure and that the scope of the present invention is to be determined by the following claims.

I claim:

1. A pet product comprising:
a collar module, wherein the collar module includes:
(a) product-specific circuitry;
(b) wireless charging circuitry, wherein the wireless charging circuitry includes a receiving coil and a rechargeable battery, wherein the receiving coil and rechargeable battery are electrically coupled to one another; and
a charging base, wherein the charging base includes a first transmitting coil, and wherein the first transmitting coil is electrically coupleable to an external source of electrical power, and further wherein when the collar module and the charging base are sufficiently close to one another for power to be inductively coupled between the first transmitting coil and the receiving coil, the rechargeable battery charges.

2. The pet product of claim 1 wherein the wireless charging circuitry further comprises resonant power receiving circuitry, wherein the resonant power receiving circuitry is electrically coupled to the receiving coil and the rechargeable battery.

3. The pet product of claim 2 wherein the wireless charging circuitry further comprises first charging communication circuitry, wherein the first charging communication circuitry is electrically coupled to the resonant power receiving circuit, the rechargeable battery, and a processor.

4. The pet product of claim 1 wherein the product-specific circuitry is selected from the group consisting of:
correction circuitry and a receiver;
a location data transmitter and a receiver;
motion sensors and data upload circuitry; and
a microphone and correction circuitry.

5. The pet product of claim 1 wherein the charging base further comprises a power module, wherein the power module includes:
power-conditioning circuitry that interfaces with the external source of electrical power; and
a power controller to supervise and control charging.

6. The pet product of claim 5 wherein the power module further comprises charging communication circuitry that performs at least one of the following functions:
(a) detection of the collar module; and
(b) communicating with the collar module in order to determine an efficiency with which the first transmitting coil couples with the receiving coil; and
(c) communicating with the collar module to determine the completion of the recharging cycle and terminate it.

7. The pet product of claim 5 wherein the power module further comprises resonant power transmitting circuitry for driving the first transmitting coil.

8. The pet product of claim 1 and further comprising an electrical cable that conducts, to the first transmitting coil, electrical power from the external source thereof.

9. The pet product of claim 8 and further comprising a cord retractor, wherein the electrical cable passes through the cord retractor.

10. The pet product of claim 2 wherein the charging base further comprises resonant power transmitting circuitry, and wherein the resonant power transmitting circuitry is tuned to a first frequency and is electrically coupled to the first transmitting coil and the external source of electrical power, and further wherein the resonant power receiving circuitry is tuned to the first frequency.

11. The pet product of claim 1 wherein the charging base further comprises a charging pad, wherein the first transmitting coil is disposed within the charging pad and further wherein the charging pad is water proof.

12. The pet product of claim 1 further comprising a second transmitting coil, a third transmitting coil, and a fourth transmitting coil, wherein the second, third, and fourth transmitting coils are electrically coupleable to the external source of electrical power.

13. The pet product of claim 11 wherein the charging pad is disposed within a pet bed.

14. The pet product of claim 11 wherein the charging pad is disposed within a floor mat.

15. The pet product of claim 11 wherein the charging pad is disposed within a wall-mounted mat.

16. The pet product of claim 11 wherein a magnet is disposed in the charging pad.

17. The pet product of claim 1 wherein the pet product is a wireless fencing system.
